(19) United States
(12) Patent Application Publication
(10) Pub. No.: US 2006/0191210 A1
(43) Pub. Date: Aug. 31, 2006

(54) Seal for covers for inscription fields

(75) Inventors: Ulrich Hetzer, Berlin (DE); Ferenc Nad, Berlin (DE); Frank Mossner, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 11/318,187

(22) Filed: Dec. 23, 2005

(30) Foreign Application Priority Data
Dec. 23, 2004 (DE) 102004061974.3-12

(51) Int. Cl. G09F 7/18

(52) U.S. Cl. 52/38

(57) ABSTRACT

The invention relates to a seal for covers for inscription fields, comprising a cover element which is intended for insertion into a base body in the form of a holder, and at least one sealing element, which can be introduced into a space between the base body and the cover element and can be compressed by the base body and the cover element, so that it is possible to seal at least a part of the area which is covered by the cover element, in which case the profile of the sealing element is designed such that, in the compressed state, a sealing effect can be achieved in its cross section at at least three points on the profile.

The invention relates to a seal for covers for inscription fields, as may be used for housings or front panels of electrical appliances or connections.

Inscription fields which are provided with a cover are frequently used in conjunction with electrical appliances, for example for telephone housings. However, they are also increasingly being required for industrial purposes, for example for identification of the data lines, electrical cables and connections, as well as associated housings or front panels which, in particular, are used in a manufacturing environment, that is to say in factory or assembly workshops, or else in the field of technical repair and maintenance, for example in workshops. The requirements in this case are comparatively stringent, particularly with regard to protection of the inscription field from dust or other items, for which reasons the covers of the inscription fields have to be sealed against oil and dirt, as well as against cleaning agents, water splashes and condensation. Seals which are used for the described application also have to satisfy further preconditions, however, in addition to providing adequate sealing. On the one hand, it is thus necessary for the seal to be simple to fit and fix. On the other hand, however, simple handling must be possible even in everyday operating conditions, for example during replacement of the covered inscription field or for cleaning, and the sealing effect must also be ensured easily and reproducibly. Furthermore, the seal should also be as simple as possible to manufacture, at as low a price as possible, and should as far as possible avoid additional manufacturing or assembly effort and the costs incurred in the process.

Simple and low-cost seals which can also be used flexibly are known and are commercially available in numerous versions. For example, it is thus feasible to use a simple rubber O-ring seal to seal the cover of an inscription field which is fitted to the housing of an outlet box for data line connections for industrial applications. However, this procedure has the significant disadvantage that, particularly if the dimensions of the seal cross section are small and the contact pressure forces acting on the seal are at the same time relatively low, as is normally the situation between a cover and a housing, the sealing effect is often inadequate. However, if the seal is made larger and higher contact-pressure forces are provided, then both the cover and the housing including the associated seal seat are correspondingly more complex to manufacture. Additional precautions must then be taken, for example by providing undercuts or holding webs in an area to be covered on a housing which is produced, for example, by die-casting or injection molding, in order to allow the seal to be fixed at all in the seal seat, to also remain there when the cover is removed and to ensure a satisfactory sealing effect all the time, despite this, after reinsertion of the cover. Furthermore, the higher contact-pressure forces for the cover and housing mean that a greater material thickness or a more robust material must be chosen. This procedure is thus complex and expensive to manufacture and, despite the use of relatively simple and low-cost seal type, generates additional costs for the production of the housing.

The invention is thus based on the technical problem of providing an improved seal for covers for inscription fields.

According to the invention, the technical problem is solved by the subject matter of claim 1. Further advantageous refinements of the invention can be found in the dependent claims.

The invention is based on the discovery that a better sealing effect than that of a conventional O-ring seal can be achieved by making use of a three-point sealing profile which, furthermore, is relatively simple and cost-effective to manufacture and which can be introduced without any problems into a seal seat, which can likewise be manufactured relatively easily and thus cost-effectively, and can be fixed there without any difficulties. According to the invention, this is achieved by proposing a seal for covers for inscription fields, which on the one hand has a cover element which is intended for insertion to a base body in the form of a holder, and on the other hand has at least one sealing element which can be introduced into a space between the base body and the cover element and can be compressed by the base body and the cover element, thus sealing at least a part of the area covered by the cover element. A sealing element is used in this case whose profile is designed such that, in the compressed state, a sealing effect is achieved in its cross section not only—as in the case of an O-ring seal—at two points, but at at least three points on the profile. The compressed state of the sealing element is in this case the state in which the cover element has been introduced into the base body and engages with it, so that the sealing element placed between the two is slightly compressed, thus resulting in a sealing effect. In contrast, the unloaded state of the sealing element is that state in which the cover element has not been introduced into the base body and is not engaged with it, for which reason the sealing element is not compressed either, and there is thus no sealing effect.

In one advantageous embodiment, the profile of the sealing element is designed such that, in the compressed state, at least a double sealing effect can be achieved by its side facing the base body, and at least a single sealing effect can be achieved by its side facing the cover element. This embodiment counters the fact that—particularly when condensation occurs or else when water splashes run down on the housing—moisture which threatens to penetrate into the inscription field in fact occurs more frequently on the housing side than on the cover side. It is thus advantageous to provide a double seal for the housing side, that is to say the side of the sealing element facing the base body, and to orient the three-point sealing element with respect to this during fitting, while it is sufficient then to provide only a single seal on the side of the cover element.

In a further advantageous embodiment, the profile of the sealing element is designed such that in the unloaded state, a cavity is formed between the sealing element and the base body on its side facing the base body. This offers the advantage that only a small amount of force then need be applied in order to compress the sealing element and thus to achieve a satisfactory sealing effect, since the material of the sealing element can then deform elastically in the direction of the cavity and there is no need to reduce the volume of the sealing element itself by compression. The contact-pressure forces which are required to ensure an adequate sealing effect are thus reduced, which leads to reduced material costs both for the housing and for the cover owing to the simpler design and the reduced material strength that is required. Furthermore, it is then possible to use a material for the sealing element which is itself not significantly compressible but just has to be elastically deformable and flexible.

In a further advantageous embodiment, the cavity is formed, with a constant profile thickness, by a projection in the form of a stud in the cross-sectional profile of the sealing element. This offers the advantage that it is possible to use a relatively flat seal profile without any additional angles and edges, which need be plastically deformed only to a minor extent during the production process in order to provide a curvature of the flat profile in the form of a stud-like projection, in order to create the desired cavity. A sealing profile such as this can thus be manufactured relatively easily and cost-effectively despite the advantageous three-point sealing effect characteristics according to the invention.

In one preferred embodiment, the profile of the sealing element has a v-shaped cross section. A v-shaped cross-sectional profile offers the advantage that the apex point in the cross section of the sealing element, which is formed by the two limbs of the v-shaped profile as they run together and produces a single sealing effect, can be defined and identified exactly. This is evident in the overall consideration of the sealing element in the form of a clearly visible apex line which runs around the surface of the sealing element, is formed by the apex points of the v-shaped profile being arranged in a row, and thus accurately identifies the area to be provided with a single seal by means of the sealing element. In this case, the profiled limbs of the seal cross section which form the v-shape are preferably arranged at an angle of about 90° to one another. However, it is also feasible to choose a considerably flatter v-shape with an angle between the profiled limbs which is greater than 90°, or else a steeper v-shape with an angle which is less than 90°.

In a further embodiment, the sealing element can be introduced into a groove provided in the base body. This results in the sealing element always being located on the seal seat, which is provided for the optimum sealing effect, even when the cover is not inserted. In this case, the sealing element is preferably held in the base body in this way, without any additional fixing. However, it is also feasible to provide additional fixing for the sealing element in the groove.

In a further embodiment, the dimensions of the groove correspond to that side of the sealing element which faces the base body, in which case the groove can be completely filled by the sealing element, at least in its compressed state, and the side of the sealing element facing the cover element projects, in its unloaded state, beyond the rim of the groove in the direction facing away from the base body. This on the one hand ensures that the sealing element is exactly matched to the shape of the seal seat and thus remains in the seal seat even without any additional fixing. On the other hand, the desired sealing effect can thus be achieved in the compressed state by elastic deformation of the sealing element, to be precise by that part of the sealing element which projects beyond the rim of the groove in the unloaded state being pushed in the direction of the base body by the cover element when in the compressed state, and being pressed into the groove, so that the cavity that is formed between the groove and the sealing element is then virtually completely filled by the sealing element.

In a further advantageous embodiment, the area to be sealed is rectangular. The rectangular shape generally corresponds to the outline of the inscription field to be covered, and can be manufactured relatively easily and cost-effectively, both with regard to the sealing element and with regard to the seal seat.

In a further advantageous embodiment, the area to be sealed has rounded corners. On the one hand, this avoids sharp-edged transitions on the seal material, thus offering manufacturing advantages while, on the other hand, a fairly linear profile of the area to be sealed has an advantageous influence on the characteristic of the sealing effect that is achieved, which thus has no sudden changes at the corner owing to the lack of abrupt transitions, and thus has a more uniform profile.

In a further preferred embodiment, the area to be sealed completely surrounds at least one inscription field. In this case, an area to be sealed which completely surrounds an inscription field is preferably located between the cover element and the base body. However, it is also feasible for an area to be sealed and which completely surrounds two or more inscription fields to be located between the cover element and the base body, or else two or more areas to be sealed, which each surround one, or in each case two or more, inscription field or fields.

In a further embodiment, the sealing element is formed from a rubber-like material. This offers the advantage that a sealing effect which is adequate for the majority of applications that occur in practice can be achieved with relatively low contact-pressure forces at the same time, at a relatively low production price and with the sealing element having good elastic deformation characteristics.

In a further embodiment, a cutout in the form of a depression is provided in the side of the sealing element facing the base body and is in the form of at least one inscription field provided between the base body and the cover element. This makes it possible to ensure that, for example, a label which is located under the cover element is located in the correct position and cannot slide.

In a further embodiment, the depression which is provided in the cover element can engage with a rim, which is provided on the base body and surrounds at least part of the inscription field. This is likewise used to make it possible to accurately position a label located under the cover element, and to prevent it from sliding. Furthermore, the engagement of the rim on the base body with the depression on the cover element once again results in an additional protective and sealing effect for the inscription field, in particular against dust and dirt.

In a further embodiment, at least one cutout which is in the form of a latching opening is provided on the cover element and can engage with at least one latching tab which corresponds to the latching opening and is provided on the base body, by which means a detachable latching connection can be formed between the cover element and the base body. This makes it possible to provide a robust and functional cover, which is particularly simple to handle, for inscription fields of any desired type and which, in addition to the sealing effect that is achieved, can also be used in an extremely versatile form. Since the cover element can easily be removed from the base body and can likewise easily be inserted into the base body again, the inscription field to be covered can thus be newly fitted or else modified as often as desired.

The invention will be explained in more detail in the following text with reference to one preferred exemplary embodiment. In the associated drawings:

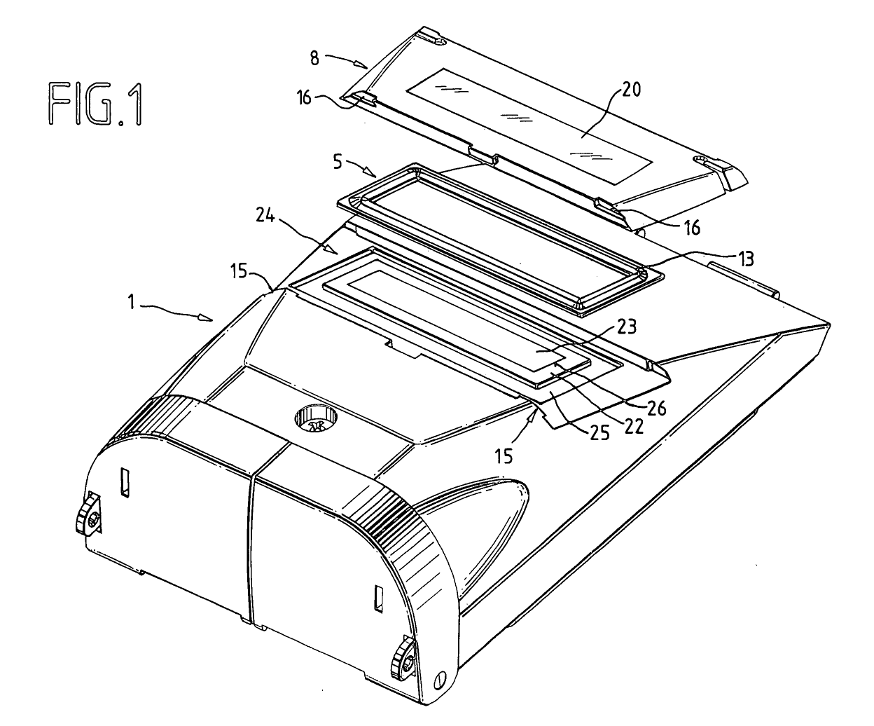

FIG. 1 shows a perspective illustration of an exploded view of one preferred embodiment of a seal according to the invention for sealing an inscription field,

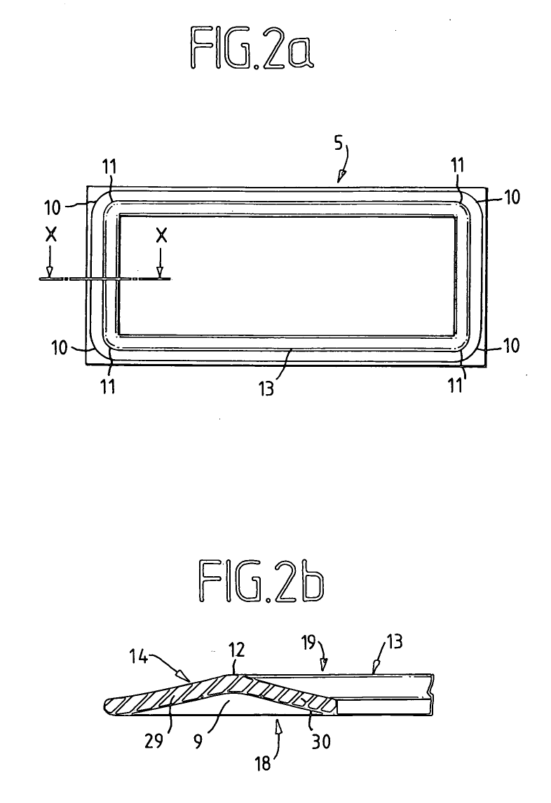

FIG. 2a shows a plan view of one preferred embodiment of the sealing element of the seal according to the invention,

FIG. 2b shows an enlarged detailed illustration of a cross-sectional view of the same embodiment of the sealing element,

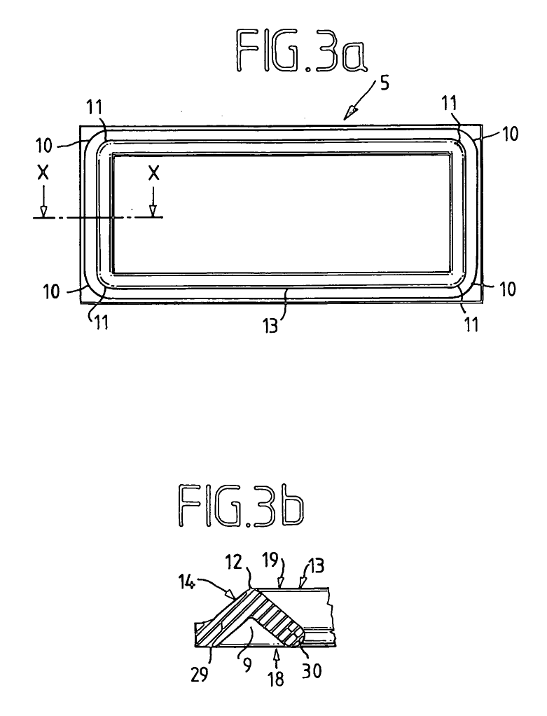

FIG. 3a shows a plan view of a further preferred embodiment of the sealing element of the seal according to the invention, and

FIG. 3b shows an enlarged detailed illustration of a cross-sectional view of the same embodiment of the sealing element.

FIG. 1 shows a perspective illustration of one preferred embodiment of a seal according to the invention for the cover for an inscription field, in the form of an exploded view. The figure in this case shows a cover element 8 which is intended for insertion into a base body 1 in the form of a holder 24. A sealing element 5 is also shown, which can be introduced into a space between the base body 1 and the cover element 8 and can be compressed by the base body 1 and the cover element 8, thus sealing a part of the area covered by the cover element 8. In this case, a three-point sealing element formed from a rubber-like material is used as the sealing element 5, and its profile is designed such that, in the compressed state, a sealing effect is achieved in its cross section at three points on the profile, with a double sealing effect then being achieved by its side 18 facing the base body 1 (see FIG. 2b), and a single sealing effect being achieved by its side 19 facing the cover element 8 (see FIG. 2b). The sealing element 5 in this case has a slightly v-shaped cross-sectional profile, in which case an apex line 13 which runs around the surface of the sealing element 5 facing the cover element 8 can be seen, which is formed by the apex points 12 (see FIG. 2b) of the v-shaped profile being arranged in a row, and accurately identifies the area provided with a single seal by means of the sealing element 5. The sealing element 5 can be introduced into a groove 25 which is provided in the base body 1 and forms the seal seat provided for the sealing element 5. The dimensions of the groove 25 in this case correspond to that side of the sealing element 5 which faces the base body 1, thus ensuring that the sealing element 5 is exactly matched to the shape of the seal seat. The sealing element 5 is thus also held in the base body 1, even without any additional fixing, even when the cover element 8 is not inserted. The groove 25 can be filled completely by the sealing element 5 in its compressed state. Furthermore, side 19 of the sealing element 5 which faces the cover element 8 projects, in its unloaded state, beyond the rim of the groove 25 in the direction facing away from the base body 1. Thus, in the compressed state, the desired sealing effect can be achieved by elastic deformation of the sealing element 5, to be precise by that part of the sealing element 5 which projects beyond the rim of the groove 25 in the unloaded state being pushed, in the compressed state, by the cover element 8 in the direction of the base body 1 and being pushed in to the groove 25, so that a cavity 9 between the groove 25 and the sealing element 5 (see FIG. 2b) is then virtually completely filled by the sealing element 5. The area to be sealed by the sealing element 5 is rectangular, with the rectangular shape corresponding approximately to the outline of an inscription field 22 to be covered, and the area to be sealed completely surrounding the inscription field 22. A cutout in the form of a depression 20 is provided in the side of the cover element 8 facing the base body 1 and has approximately the same shape as the inscription field 22 provided between the base body 1 and the cover element 8. Furthermore, the depression 20 provided in the cover element 8 can engage with a rim 26, which is provided on the base body 1 and surrounds the majority of the inscription field 22. Furthermore, two cutouts in the form of latching openings 16 are provided on the cover element 8 and can engage with two latching tabs 15 which correspond to the latching openings 16 and are provided on the base body 1, thus making it possible to form a detachable latching connection between the cover element 8 and the base body 1.

FIG. 2a and FIG. 3a show plan views of in each case one preferred embodiment of the sealing element 5 of the seal according to the invention. These figures in each case show that the area to be sealed by sealing element 5 is rectangular and is bounded on the surface of the sealing element 5 facing the cover element 8 by the circumferential apex line 13. Furthermore, each of these views clearly show that the area to be sealed has rounded corners 10, 11.

FIG. 2b and FIG. 3b each show an enlarged detailed view of the cross-sectional view of the embodiments of the sealing element 5 shown in FIG. 2a and FIG. 3a, respectively. In this case, the section is in each case along the line X-X illustrated in FIG. 2a and FIG. 3a. In this case, the sealing element 5 is in each case shown in its unloaded state, that is to say in the state in which the sealing element 5 is not compressed, since the cover element 8 has not been introduced into the base body 1 and is not engaged with it. The figures in each case show that a cavity 9 is formed between the sealing element 5 and the base body 1 on the side 18 of the sealing element 5 facing the base body 1. This design makes it possible for the sealing element 5 to be elastically deformed in the direction of the cavity 9 in order to achieve the desired sealing effect with a relatively small amount of force being applied. In this case, with the profile thickness otherwise being constant, the cavity 9 is formed by a projection 14 in the form of a stud in the cross-sectional profile of the sealing element 5, so that it is possible to use a relatively flat sealing profile without any additional angles and edges in production, which need be plastically deformed only to a minor extent during the production process in order to produce curvature of the flat profile in the form of a stud-like projection 14 in order to create the desired cavity 9. In the preferred embodiment illustrated in FIG. 2a and in FIG. 2b, the profile of the sealing element 5 has a slightly v-shaped cross section. The angle between the two profile limbs 29, 30 is in this case greater than 90°, which leads to a relatively flat seal profile. In the further preferred embodiment illustrated in FIG. 3a and in FIG. 3b, the profile of the sealing element 5 has a more pronounced v-shaped cross section. In this case, the angle between the two profile limbs 29, 30 is approximately 90°, which lead to a somewhat steeper seal profile. As can be seen from the two embodiments, the apex point 12 is in each case formed in the cross section of the sealing element 5, which produces a single sealing effect on the side 19 facing the cover element, by the respective two profile limbs 29, 30, which run together, of the slightly or more strongly pronounced v-shaped profile. As has already been shown in the plan views of the sealing element 5 (see FIG. 2a and FIG. 3a), an apex line 13 which runs around the surface of the sealing element and identifies the area provided with a single seal by means of the sealing element 5 is in each case formed by arranging all of the apex points 12 of the slightly or more pronounced v-shaped profile of the sealing element 5 in a row.

### LIST OF REFERENCE SYMBOLS

1 Base body
5 Sealing element
8 Cover element
9 Cavity
10, 11 Rounded corners
12 Apex point
13 Apex line
14 Projection in the form of a stud
15 Latching tab
16 Latching opening
18 Side of the sealing element facing the base body
19 Side of the sealing element facing the cover element
20 Depression
22 Inscription field
23 Label
24 Holder
25 Groove
26 Rim
29, 30 Profiled limbs

1. A seal for inscription fields, comprising:
a cover element which is intended for insertion into a base body in the form of a holder and at least one sealing element, which can be introduced into a space between the base body and the cover element and can be compressed by the base body and the cover element, so that it is possible to seal at least a part of the area which is covered by the cover element, wherein the profile of the sealing element, defines a sealing effect in its cross section in at least three points on the profile in the compressed state between the base body and the cover element.

2. The seal as claimed in claim 1, wherein the profile of the sealing element, defines at least a double sealing effect by a side facing the base body, and at least a single sealing effect by a side facing the cover element in the compressed state.

3. The seal as claimed in claim 1, wherein the profile of the sealing element, defines a cavity between the sealing element and the base body on a side facing the base body in the unloaded state.

4. The seal as claimed in claim 3, wherein the cavity is formed, with a constant profile thickness, by a projection in the form of a stud in the cross-sectional profile of the sealing element.

5. The seal as claimed in claim 1, wherein the profile of the sealing element has a v-shaped cross section.

6. The seal as claimed in claim 1, wherein the sealing element is sized to fit into a groove provided in the base body.

7. The seal as claimed in claim 6, wherein the dimensions of the groove correspond to a side of the sealing element which faces the base body, in which case the groove can be completely filled by the sealing element, at least in its compressed state, and a side of the sealing element facing the cover element projects, in its unloaded state, beyond a rim of the groove in the direction facing away from the base body.

8. The seal as claimed in claim 1, wherein the area to be sealed is rectangular.

9. The seal as claimed in claim 8, wherein the area to be sealed has rounded corners.

10. The seal as claimed in claim 1, wherein the area to be sealed completely surrounds at least one inscription field.

11. The seal as claimed in claim 1, wherein the sealing element is formed from a rubber-like material.

12. The seal as claimed in claim 1, wherein a cutout in the form of a depression is provided in the side of the sealing element facing the base body and is in the form of at least one inscription field provided between the base body and the cover element.

13. The seal as claimed in claim 12, wherein the depression which is provided in the cover element can engage with a rim, which is provided on the base body and surrounds at least part of the inscription field.

14. The seal as claimed in claim 1, wherein at least one cutout which is in the form of a latching opening is provided on the cover element and can engage with at least one latching tab which corresponds to the latching opening and is provided on the base body, by which means a detachable latching connection can be formed between the cover element and the base body.

15. A sealing element for inscription fields, for use in sealing a space between a base body and a cover element, comprising:
a compressible body having an enclosed shape sized to fit into the space wherein the profile of the sealing element is configured such that, in the compressed state, a sealing effect can be achieved in its cross section at at least three points on the profile.

16. The sealing element as claimed in claim 15, wherein the enclosed shape of the compressible body is rectangular.

17. The sealing element as claimed in claim 15, wherein the profile of the sealing element has a v-shaped cross section.

18. An inscription field sealing apparatus comprising:
a base body having an outer face, the outer face defining an inscription area, and a groove surrounding the inscription area;
a cover element mountable to the body to cover the inscription area, the cover element including a sealing surface facing the groove of the base body;
a sealing element having a compressible body and defining an enclosed shape to fit in the groove of the base body, the sealing element having a profile in cross-section that defines at least three seals between the cover element and the base body.

19. The apparatus as claimed in claim 18, wherein the enclosed shape of the sealing element is rectangular.

20. The apparatus as claimed in claim 18, wherein the profile of the sealing element has a v-shaped cross section.
